(19) United States
(12) Patent Application Publication
(10) Pub. No.: US 2014/0250489 A1
(43) Pub. Date: Sep. 4, 2014

(54) Techniques for Policy Aware Service Composition

(71) Applicant: International Business Machines Corporation, (US)

(72) Inventors: Seraphin B. Calo, Cortlandt Manor, NY (US); Raheleh B. Dilmaghani, Elmsford, NY (US); Keith W. Grueneberg, Stewart Manor, NY (US); Jorge Lobo, New York, NY (US); Jian Xu, San Jose, CA (US); Petros Zerfos, New York, NY (US)

(73) Assignee: International Business Machines Corporation, Armonk, NY (US)

(21) Appl. No.: 13/769,469

(22) Filed: Feb. 18, 2013

(51) Int. Cl. H04L 29/06

(52) U.S. Cl. CPC H04L 63/20
USPC 726/1

(57) ABSTRACT

Techniques for policy-aware service composition are provided. In one aspect, a method for creating a policy-compliant service composition is provided. The method includes the following steps. One or more policy rules related to services in the service composition are created. A service composition graph is created that represents the service composition, wherein vertices of the service composition graph represent the services and directional edges of the service composition graph represent potential flows of data between the vertices. During creation of the service composition graph, it is determined whether one or more candidate services comply with the policy rules. Only those of the candidate services that comply with the policy rules are included in the service composition graph, wherein the services included in the service composition graph comprise policy-compliant services, such that the service composition graph comprises only the policy-compliant services.

### STATEMENT OF GOVERNMENT RIGHTS

This invention was made with Government support under Contract number W911NF-06-3-0001 awarded by U.S. Army. The Government has certain rights in this invention.

### FIELD OF THE INVENTION

The present invention relates to policy-aware service composition (PASC) and more particularly, to service composition for different applications such as sensor networks.

### BACKGROUND OF THE INVENTION

A service composition that is subject to given constraints has been extensively studied in the domain of web services. However, prior approaches are developed around the request-response interaction model of the web services environment and attempt to enforce either constraints imposed on individual component services or focus solely on security constraints and access control. Constraints imposed on individual component services are described, for example, in E. Bertino et al., “A Fine-grained Access Control Model for Web Services,” In Proc. of Services Computing Conference (SCC), 2004 (hereinafter “Bertino”) and in E. Damiani et al., “Fine Grained Access Control for SOAP E-Services,” In Proc. of International Conference of Web Services (ICWS), May 2001 (hereinafter “Damiani”). Constraints imposed based on security constraints and access control are described, for example, in B. Carminati et al., “Security Conscious Web Service Composition,” IEEE International Conference on Web Services, 2006. ICWS'06, pages 489-496, IEEE, 2006 (hereinafter “Carminati”) and in J. Han et al., “Security-Oriented Service Composition and Evolution,” 13th Asia Pacific Software Engineering Conference, 2006 (APSEC'06), pages 71-78, IEEE, 2006 (hereinafter “Han”).

Recent works look at the evaluation of policies defined over information flows in a service composition, which seems to be more applicable to the dataflow model of sensor services, but the policy model assumed is limited and able to express only access control constraints based on multi-level security classes of information flows. See, for example, W. She et al., “Policy-Driven Service Composition with Information Flow Control,” IEEE International Conference on Web Services, 2010 (hereinafter “She”). While a step in the right direction, multi-level access control policies by themselves are not rich enough to express the management requirements of an operational sensor network infrastructure. For example, it is not possible to state conditions regarding the use of component services in a service composition graph based on metrics of resource utilization of the sensor nodes, a typically mandatory requirement in sensor network deployments that involve shared hardware, software and network components.

The structure of distributed sensor network applications and services typically consists of a sequence of transformation and aggregation processing steps that execute on measurement data collected by the various sensing modalities of the sensor nodes. See, for example, N. Xu et al., “A Survey of Sensor Network Applications,” IEEE Communications Magazine, 40 (2002) (hereinafter “Xu”). As such, it naturally lends itself to a service composition paradigm that is based on dataflow processing graphs, which can be further used to automate the synthesis of complex sensor services. See, for example, S. Geyik et al., “Dynamic Composition of Services in Sensor Networks,” IEEE International Conference on Service Computing SCC, pgs. 242-249 (2010) (hereinafter “Geyik”). However, such synthesis of a composite service through a combination of more primitive ones is usually subject to various constraints that are set by sensor network management and security systems, which are tasked with dynamically allocating network resources and regulating the sharing of the common sensor infrastructure among multiple applications that might run on it. Controlled sharing in particular becomes an important requirement in deployments where a common sensor infrastructure is contributed by multiple organizations with disparate administrative domains, each of which has its own policies with respect to how the sensor nodes and platforms will be used by the other partner organizations.

Therefore, a policy model and service composition approach that overcomes the aforementioned limitations would be desirable.

### SUMMARY OF THE INVENTION

The present invention provides techniques for policy-aware service composition. In one aspect of the invention, a method for creating a policy-compliant service composition is provided. The method includes the following steps. One or more policy rules related to services in the service composition are created. A service composition graph is created that represents the service composition, wherein vertices of the service composition graph represent the services and directional edges of the service composition graph represent potential flows of data between the vertices. During creation of the service composition graph, it is determined whether one or more candidate services comply with the policy rules. Only those of the candidate services that comply with the policy rules are included in the service composition graph, wherein the services included in the service composition graph comprise policy-compliant services, such that the service composition graph comprises only the policy-compliant services.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating an exemplary composite service graph of an “object identification and tracking” sensor service according to an embodiment of the present invention;

FIG. 2 is a table showing examples of policy rules written on the composite service graph of FIG. 1 using the present policy\model according to an embodiment of the present invention;

FIG. 3 is a diagram illustrating an exemplary methodology for policy evaluation according to an embodiment of the present invention;

FIG. 4 is a diagram illustrating an exemplary methodology for creating a policy-compliant service composition that employs the present policy model and dynamic policy evaluation procedures to ensure compliance according to an embodiment of the present invention;

FIG. 5 is a diagram illustrating an exemplary design of policy-enabled service composition in a sensor network middleware infrastructure (Sensor Fabric) according to an embodiment of the present invention;

FIG. 6 is a graph illustrating time to complete sensor service composition with policy checking for different number of policies evaluated, for different percentages of policy violations (failure) according to an embodiment of the present invention;

FIG. 7 is a graph illustrating composite service cost produced with policy-aware service composition with different numbers of policies evaluated, for various percentages of policies evaluating to false (failure) according to an embodiment of the present invention; and

FIG. 8 is a diagram illustrating an exemplary apparatus for performing one or more of the methodologies presented herein according to an embodiment of the present invention.

### DETAILED DESCRIPTION OF PREFERRED EMBODIMENTS

Sensor applications are typically composed of a number of functional components that run distributedly on the nodes of a sensor network, communicating and interacting with one another. Service composition is emerging as a viable approach towards the automatic synthesis of such sensor applications. However, for service composition to be practical, it has to comply with policies that define access controls, data types, security and management constraints on the use of these service components and the interconnections amongst them. Prior research efforts have primarily focused on efficient evaluation of security policies during the composition process, which is not sufficient when generic network management constraints need to be expressed and evaluated. Provided herein is a policy model and evaluation method that enables one to define and check attribute-based policies, and local and global policies regarding directly interacting and non-directly interacting nodes for a service composition process, and to select policy-compliant services in the service composition. The attribute-based policies are generic which allows a wider spectrum of constraints to be expressed than is currently possible. While examples will be provided for use of the present policy model and evaluation method in the context of a sensor service, it is to be understood that the present techniques are broadly applicable to secure communications, with constraints on access, resources, energy, signal strength, etc. Basically, the techniques provided herein are broadly applicable to defining a wide variety/broad set of policies, such as any constraint on any field in a service (attribute) including energy, distance, signal strength, affiliation, etc.

The present techniques focus on addressing the following two challenges in service composition: the first challenge being expressing and evaluating generic policies that are able to capture the characteristics of the complete service graph, as opposed to the more narrow scope of information flows or individual service nodes/instances. Such policies might refer to aggregate characteristics of the composite service (e.g., “do not include in the service composition more than 3 instances of service A that are provided by organization B”), or span arbitrary service processing pipelines (also referred to as “service chains” in She, the contents of which are incorporated by reference herein), which might not necessarily be connected through an information flow (e.g., “do not include service instance C in the composition if service instances A and B are included,” wherein services “A,” “B,” and “C” are not necessarily part of an information flow).

The second challenge that the present techniques address is that of efficiency in policy evaluation: as a potentially large number of candidate composite service graphs might be generated as a result of a composition request, the overhead of evaluating all the policy constraints for each service component selected, as well as on the overall graph, might be prohibitively high for the service composer. It is imperative that evaluation of policies be fast for practical service composition in a sensor network environment, in which dynamic re-composition of sensor services might take place often due to continuously varying node resources and connectivity.

To address these challenges, provided herein is a unique policy model and evaluation method that can be used with a service composition process to allow only policy-compliant services to appear in the service composition graph. A resource model has been developed that exposes the characteristics of such service composition graphs to a policy language, so as to enable authoring and evaluation of attribute-based policies. This tool, called a policy management library (or PML) implements components of a well-known policy management architecture and provides a generalized policy model able to support arbitrary policy languages. PML is described, for example, in Johnson et al., “Usable Policy Template Authoring for Iterative Policy Refinement,” POLICY '10 Proceedings of the 2010 IEEE International Symposium on Policies for Distributed Networks,” pgs. 18-21 (2010); Beigi et al., “A Negotiation Framework and a Reference Implementation for Negotiation of Coalition Policies,” Annual Conference of International Technology Alliance (ACITA) 2010 (September 2010); Doganata et al., “Authoring and deploying business policies dynamically for compliance monitoring,” IEEE International Symposium on Policies for Distributed Systems and Networks (POLICY), Jun. 6-8, 2011 (August 2011); Johnson et al., “Optimizing a Policy Authoring Framework for Security and Privacy Policies,” Symposium on Usable Privacy and Security (SOUPS) 2010, (Jul. 14-16, 2010); Gruenberg et al., “Policy Supersession in a Coalition ISR Network,” 2011 IEEE International Symposium on Policies for Distributed Systems and Networks (2011); Doganata et al., “Authoring and deploying business policies dynamically for compliance monitoring,” 2011 IEEE International Symposium on Policies for Distributed Systems and Networks (2011), the contents of each of which are incorporated by reference herein. It is notable that while PML is useful for implementing policies as it permits evaluation of attribute-based policies, the present techniques are in no way limited to use of PML. The present policy paradigm is flexible and can be implemented using any language of choice, etc. PML is thus just an example. Attribute-based policies are able to express more general constraints than those based on multi-level security classes. The policy model is extensible and allows for incremental support of progressively more complicated constraints expressed over such graphs.

To make the evaluation of service composition policies efficient, a method is also provided herein for checking policy constraints during the service composition process, at runtime, as the service graph is being constructed. While the approach in She checks for compliance after all candidate composition graphs have been generated, the present method allows for early elimination of service instances that might violate policy constraints, which decreases the time needed for composition and policy checking and reduces the number of candidate services that need to be checked. In an exemplary implementation, both the policy model and the evaluation method are implemented utilizing a sensor service composition methodology using a Sensor Fabric, a middleware framework for developing distributed sensor network applications and services. The Sensor Fabric framework is described, for example, in J. Wright et al., “A Dynamic Infrastructure for Interconnecting Disparate ISR/ISTAR Assets (the ITA Sensor Fabric),” IEEE/ISIF Fusion Conference, July 2009 (hereinafter “Wright”), the contents of which are incorporated by reference herein.

In summary, the present techniques provide the following: 1) a policy model that is able to express attribute-based policies, and local and global policies concerning any set of nodes, separation of responsibilities, and policies on the structure of a service composition graph; 2) a new policy evaluation methodology that checks at runtime the service composition graph that is being constructed, leading to a faster service composition and policy check process; and 3) a unique implementation of the present policy-aware service composition approach in Sensor Fabric, a software framework for sensor network application and services. Preliminary performance evaluation results are also presented.

In Geyik, the contents of which are incorporated by reference herein, a service model was introduced for describing sensor services that intuitively captures the aforementioned salient characteristics and interdependencies among the individual sensor services that comprise complete applications. This model is adopted in the present techniques. It is notable however that the present techniques can use any service composition process. The service composition model provided by Geyik is only being used herein as an example. According to Geyik, a sensor service sᵢ is defined by the input data that it accepts denoted as an ordered list of typed fields, the transformation function that it applies to its input, the output data that it produces as an ordered list of typed fields, as well as metadata, which provides additional information that characterizes the service and its outputs:

sᵢ={inputᵢ=(input_{i,l}, . . . ,input_{i,m});

outputᵢ=(output_{i,l}, . . . ,output_{i,k});

∫ᵢ(inputᵢ)→(outputᵢ),metadataᵢ(t)}.

Although the inputs and outputs of a sensor service change with time, to abbreviate the notation, the t subscript is omitted, which instead is implied.

In the above service definition, metadata carries information about the data and the services that process it, following the approach described in J. Ibbotson et al., “The Case for an Agile SOA,” First Annual Conference of the International Alliance, September 2007 (hereinafter “Ibbotson”), the contents of which are incorporated by reference herein. Metadata may contain properties of the data such as levels of reliability, as well as cost information and certain characteristics of the service itself, such as energy consumption per output data produced, processing delays, number of other services that make use of its outputs, etc.

A composite sensor service, i.e., a service that is provided through a suitable combination of a plurality of other, simpler services, is represented by a service graph G_{S}. The vertices of a service graph represent services and directional edges denote the potential data flows between them. The edge directed from the vertex of service A to the vertex of service B is created if and only if the output of A and input of B intersect in some fields (i.e., the type of input field is same as the type of the output field). That is, informally, A can provide some of the data that it produces (output) for use by B through this directional edge. Additionally, it is required in this example that each input of B is connected to at least one output of some service. A formal definition of the service graph is given below:

$${G}_{x} = \{ V , E \} and$$

$$V = \{ {s}_{i} \} ( one vertex per service ) and$$

$$E ⊆ VxV , where {e}_{i , j} = \{ \begin{matrix}1 & if {output}_{i} ⋂ {input}_{j} \neq \\ 0 & otherwise\end{matrix}$$

Policy Model:

As highlighted above, the present techniques provide a policy model that is able to express attribute-based, and local and global policies for service composition graphs. The policy model is now described. Namely, the instant techniques present a model to define specifications of policy rules. This model is used in the context of service composition and handles constraints among directly and indirectly interacting services in the given service graph. In the present policy model, the tuple representation of a service si (also referred to herein as a service definition) is used with its input set, metadata and output set as described above. As an example, metadata can include service node affiliation (e.g., entity—such as company, country, etc. with which the service node is affiliated) and type (e.g., camera sensor service, camera sensor recognition service, triangular service, event detector service, acoustic sensor service, etc.). Furthermore, policy rules define service selection criteria. Thus, the present techniques extend the previously proposed service composition model (such as that described in Geyik) to check for policies at the time of composition as required by service descriptions.

The present techniques augment the composite sensor service model with the following definitions that will be used for policy evaluation:

### Definition 1

Service Arguments and Variables—A service argument refers to a service input, output, or metadata field and is represented by the. notation after the service name. A variable argument is a service argument where the service name is replaced by a term of the form V[i], where i is a positive integer. A service variable is denoted as V[i]. Metadata can refer to signal strength, energy, location, time, communication cost, etc.

### Example 1

V [1] is a service variable that refers to any service. V [1]: I D is a variable argument that refers to any service with the field I D.

### Definition 2

Valid argument—A service argument is valid if that argument is defined for that service as a field.

### Definition 3

Compatible Services—Two services are compatible if at least one of the output fields of one service intersects with at least one of the input fields of the other service.

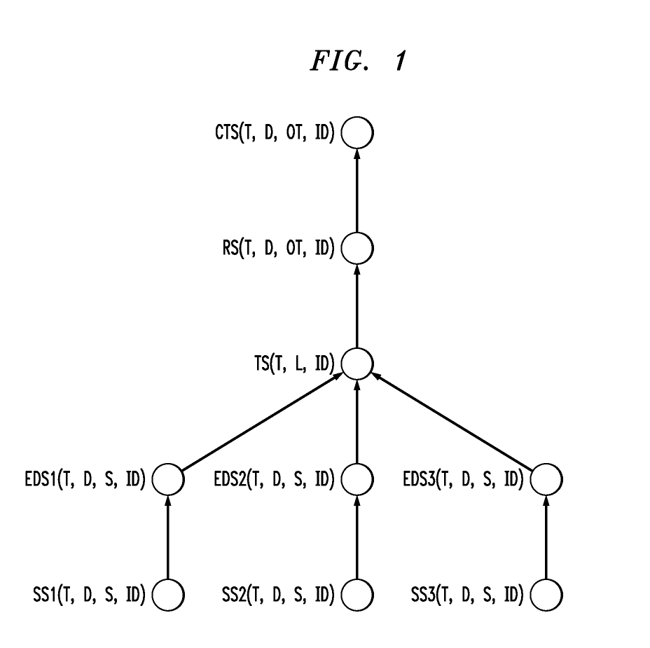

As a working example for the illustration of the policy model and evaluation method that is following, consider the composite service graph of FIG. 1, which illustrates an exemplary hypothetical sensor application used for “object identification and tracking.” Audio measurements from three acoustic Sensor Services, SS are collected by an Event Detector Service, EDS, and are used to localize the source of sound through a Triangulation Service, TS. The results of triangulation are then transmitted to a camera Recognition Service, RS, to identify the type of the object that was the source of sound. The output of the camera recognition service is finally fed to the Camera sensor Tracking Service, CTS, to allow for the camera to tilt towards the direction of the object. In the example shown in FIG. 1, ID denotes identification or affiliation of the node, T denotes time, D denotes distance, L denote location, S denotes strength and OT denotes object type. Identification or ID is a field that indicates affiliation and is used to state constraints and access control based policies on affiliation which is important in many secure applications such as a coalition scenario.

Using the above extended service model, policy rules are defined as follows:

### Definition 4

Policy Rule—A policy rule is a triplet of [Arguments; Constraint; Service Node] where: 1) Arguments are a set of service or variable arguments as defined in Definition 1; 2) Constraints are equality or inequality conditions involving arguments that refer to metadata fields or constants; and Service Node is a service or a service variable.

Given a policy rule, an instance of that rule is the policy rule that results after replacing every service variable with the name of a service. An instance of a policy rule is valid if all the arguments in the instance are valid.

### Example 2

Given a policy rule of [V [1]; V [1]:ID=US; V [1]], an instance of the policy rule is [SS1; SS1:ID=US; SS1]. Another instance is [CTS;CTS:ID=US;CTS], etc. This policy defines a rule that only adds acoustic sensor services that are United States (US) affiliated.

### Example 3

V [1]:D is a valid argument for services of type SS, EDS, RS, and CTS but it is not a valid argument for service type TS. Hence, given a policy rule of [V [1]:D; V [1]:ID=US; V [1]], there is no valid instance of the rule for service type TS.

### Definition 5

Composition path—A composition path is a set of directed edges among compatible services. Given a set of n services, S1; S2; Si; Si+1 . . . Sn and sequence of n−1 composition operation among them, a composition path is represented as a set of pairs of compatible service arguments, such as <S₁·Oₐ,S₂·I_{b}>, . . . , <Sᵢ·O_{c},Sᵢ₊₁·I_{d}>, . . . , <Sₙ₋₁·Oₑ,Sₙ·I_{f}>, where a; b; c; d; e; f; m; n are all integers, a; c; e<=m and b; d; f<=1, which indicates that the input or output index of each service has to be smaller than or equal to the largest index of input or output for that service, i.e., a valid index number for the input or output of that service, and the services participating in the composition operation all appear on a path in the service composition graph. Input set of a service Sᵢ is defined as I_{S}_{ᵢ}={Si·I₁, Si·I₂, . . . , Si·Iₘ} where m is an integer, and is the largest index number for the inputs of that service; output set O_{S}_{ᵢ} consists of the set of output fields, i.e., O_{S}_{ᵢ}={Si·O₁, Si·O₂, . . . , Si·Oₗ} where l is an integer, and l is the largest index number for the outputs of that service.

### Definition 6

Applicable Policy Instances—Given a service composition graph and a policy instance, the policy instance is applicable if: a) the Service Node appears as a vertex in the service composition graph and b) all of the services mentioned in the arguments appear as vertices in the service composition graph and c) there are composition paths in the service composition graph between the service node and every service mentioned in the arguments.

If no applicable policy exists, the node is selected for service composition as if there were no policy to be evaluated.

### Definition 7

Violation of a policy—A node in a service composition graph violates a policy if there is an instance of that policy that is applicable and the Constraint is violated.

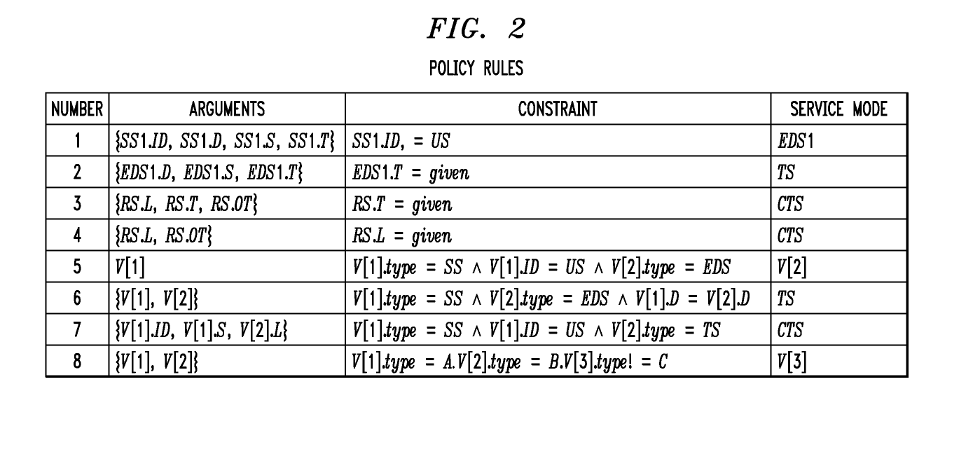

Table I (also referred to herein as a policy table or PT) shown in FIG. 2 presents examples of policies (policy rules) written on the exemplary composite service graph of FIG. 1 using the present policy/model. As shown in the policy table of FIG. 2, Policy 1 defines a rule that service node EDS1 (the event detector sensor) can access any arguments of the acoustic sensor service tuple (SS1), if SS1 is affiliated with the United States (US). For example in a coalition scenario, it is US policy to access only US-affiliated sensors. In another example, the constraint is to access data at a certain time because after that the data source might have been compromised. Policy 2 defines a policy that the triangulation service TS can access distance and signal fields of EDS1 service at a given time. Policy 3 defines access to sensor RS by camera tracking sensor service CTS at a given time (for recognition service RS). Policy 4 defines access to arguments of RS service from a given location. Policy 3 and 4 together allow the CTS service to access the RS service from a given location at a given time. Policy 5 defines a rule for EDS node type to access arguments of acoustic sensor node type SS for US-affiliated acoustic sensors. Policy 6 is a policy defining a rule for triangulation service to access event detector type sensor and acoustic sensor when sensors are co-located. This policy defines a constraint on more than one node. Policy 7 also refers to global properties of the composite service graph and dictates that camera tracking service can access acoustic sensor types and triangulation service types if data is from US-affiliated acoustic sensor. Lastly, policy 8 defines a rule for a service node, such that if the service node depends on services of type A and B, then the service node cannot involve a service of type C. As another example, if a service depends on data from two different types of sensors, acoustic and event detection for example, it cannot include a service of type “smoke detector.”

The above policy model allows attribute-based policies to be defined that state conditions about service compatibility that are more general as compared to simple multi-level security classes, thus controlling the potential flow of information in a more generic manner. The term “attribute” refers to arguments in policy definition that can be any field, i.e., input, output or metadata field of a service definition (see Definition 1 above). This policy model allows the definition of constraints on data types, access control, network management and security that are useful in coalition, secure organizational communication/secure work flow, etc. The above policy model also enables policies to be expressed that are global in the sense that the policies include constraints over a collection of the nodes across the composition graph that might not be necessarily connected (by comparison, local policies are considered herein to be those policies that concern only directly connected/interacting nodes with the current service node that is being composed during the creation of a policy-compliant service composition (immediate neighboring service nodes that either produce an output that is an input to the current service of interest or consume the output of the service of interest—see, e.g., FIG. 4, described below). Finally, as seen in policy 8 above, policies that refer to the separation of responsibilities can be expressed using this model.

Policy Evaluation:

To evaluate a service composition against the given policies, use is made of the following definition:

### Definition 8

Feasible composition—A composition is feasible (policy-compliant) if and only if there is no violation of policies with respect to a given service composition graph.

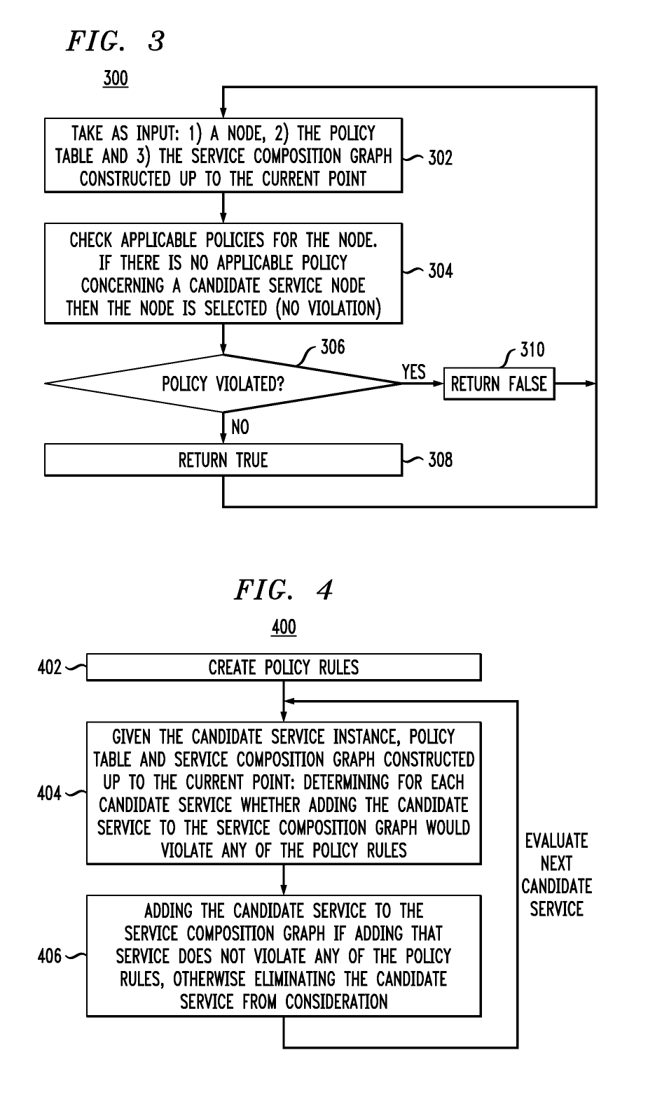

FIG. 3 is a diagram illustrating an exemplary methodology 300 for evaluating policies and selecting only policy-compliant services. According to an exemplary embodiment, policy evaluation as per methodology 300 is performed during the composition process (i.e., at runtime) for every candidate service S that is being considered for selection in the service composition graph that is currently being constructed. It does so by determining whether adding this candidate service to the current service composition will not violate any policy. Specifically, in step 302 methodology 300 takes as input a node (i.e., the candidate service instance S), the policy table PT, as well as the service composition graph G_{S} that has been constructed up to that point, assuming that the candidate service instance has been added to the graph. In step 304, methodology 300 checks the applicable policies for the node, i.e., entries in the policy table PT where the node is either a service node or appears in the arguments. It is notable that if there is no applicable policy concerning a candidate service node, then the node is selected (no violation). In step 306, a determination is made as to whether the node violates any of the policies (policy rules). If there is a policy violation (i.e., a policy violation either where the node is a service node or appears in the arguments) then in step 310 the methodology 300 returns false if the policy is violated in the service composition graph. On the other hand, if none of the policies are violated, then in step 308 the methodology 300 returns true. As shown in FIG. 3, this process is repeated for each of the nodes.

Methodology 300 is used in conjunction with a service composition methodology, more specifically when service selection is performed. In the system and performance evaluation experiments that are described below, the centralized version of the service composition process of Geyik is employed.

Given the above description of the present policy model and policy evaluation process, FIG. 4 provides an exemplary methodology 400 for creating a policy-compliant service composition that employs the present policy model and dynamic policy evaluation procedures to ensure compliance. In step 402, one or more policy rules are created. These policy rules form a policy model against which the service composition can be based to ensure policy compliance.

As described above, the policy model defines policy rules in the context of the service composition, i.e., relating to directly and indirectly interacting services in the service graph. In general, the policy rules impose constraints on a service's or services' (identified based on service name or service variable—see above) inclusion in the service composition graph based on data (e.g., input data, output data and/or metadata) associated with the service or services. The constraints can include properties of nodes/services and/or the path. Constraints can be defined on service attributes or arguments explained above, i.e., input, output and metadata fields, authentication, data types and/or source selection. Service node affiliation, type of data that it provides (i.e., data type), and the location are a few sample criteria to select sources that can be defined by the policies. More specifically, as provided above, each policy rule has: 1) an arguments component (i.e., a set of one or more service arguments and/or one or more variable arguments—see Definition 1, above), 2) a constraint component (equality or inequality conditions involving arguments that relate to metadata fields), and 3) a service node component (i.e., a service node—a service name (such as SS1) or service variable—such as V[i]).

Next, given the policy rules and one or more candidate services, a service composition graph is created. Candidate services S_{C} are the services that output of which can be consumed by another service(s). Namely, candidate services are potential candidates for providing one or more inputs to the next service. As provided above, a service composition graph is used to represent the composite sensor service wherein the vertices of the service composition graph represent services and directional edges represent the potential flows of data between the services. To construct the service composition graph, in step 404, for each candidate service being considered for selection in the service composition graph (i.e., on a service-by-service basis), a determination is made as to whether adding this candidate service to the service composition graph would violate any of the policy rules. As described above, a given policy rule is applicable to a given service node if 1) the given service node appears as a vertex in the service composition graph, 2) all services mentioned in the policy rule appear as vertices in the service composition graph, and 3) there are composition paths in the service composition graph between the given service node and each of the services mentioned in policy rule. Based on these criteria of policy applicability, step 404 may be performed by determining on a policy-by-policy and service-by-service basis whether the criteria are met. As provided above, if no applicable policy exists, then the service node is selected for the service composition as if there were no policy to be evaluated.

In step 406, based on the above (service-by-service) evaluation, a given candidate service is added to the service composition graph if adding that service does not violate any of the policy rules, otherwise the given candidate service is eliminated from consideration. As indicated in FIG. 4, the process then begins again at step 404 with evaluation of another candidate service.

System Design and Implementation:

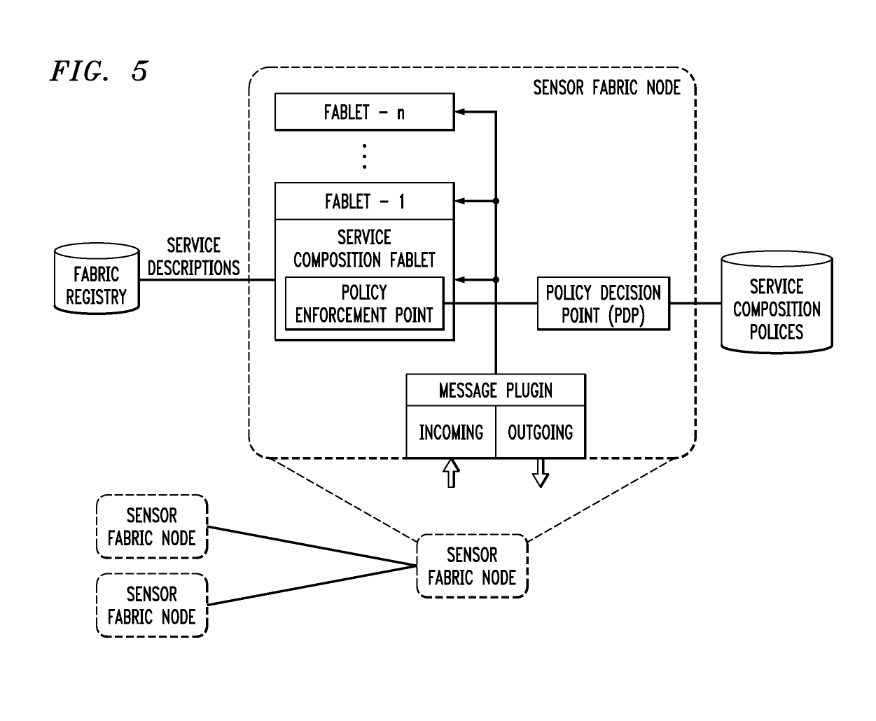

a unique implementation of the policy model and policy evaluation method is developed. This implementation utilizes the centralized service composition process of Geyik using the Sensor Fabric (see Wright) environment. See FIG. 5. It is notable however that the present policy model and evaluation methodology can use any service composition process and this implementation using the service composition process of Geyik is merely an example that is being used to illustrate the present techniques. The Sensor Fabric is a middleware architecture designed to simplify the development and operation of sensor network applications and services by automating tasks such as sensor node discovery, connection and management. The Sensor Fabric follows a Service Oriented Architecture (SOA) approach to sensor network development and provides a two-way messaging bus along with a set of middleware services for transparent handling of connectivity and routing among sensor nodes. As shown in FIG. 5, service descriptions, the composite service model (as described above), as well as infrastructure information about the Sensor Fabric are stored in a Fabric Registry. The Fabric Registry is a distributed, federated database whose instances are attached to each Fabric node. For a description of a federated database, see for example G. Bent et al., “A Dynamic Distributed Federated Database,” In Proc. of ACITA, September 2008 (hereinafter “Bent”), the contents of which are incorporated by reference herein.

The centralized service composition capability of Geyik was implemented as a “Fablet” service in the Sensor Fabric. See FIG. 5. A Fablet is a software plug-in running within the Sensor Fabric middleware, implementing a container abstraction through which the Sensor Fabric can be extended with new, user-defined sensor services. Fablets are event-driven and apply processing logic as they receive incoming messages. The service composition fablet obtains the component service descriptions from the Fabric Registry and runs the policy-enabled service composition method once the service composition fablet receives an appropriate “trigger” message (see “incoming and “outgoing” message plug-in in FIG. 5) from the sensor node. A Policy Enforcement Point (PEP) that is implemented in the service composition fablet enforces the results of policies that are evaluated by a Policy Decision Point (PDP) that runs on the sensor node, as per methodology 300 (FIG. 3, described above). These policies are obtained by the PDP from the policy repository (labeled “Service Composition Policies” see FIG. 4), which may be local, remote or even distributed (see, e.g., Bent). The policy repository allows for dynamic modifications of the set of policies during the operation of the system. Once the (local) service composition process is completed, the composite service graph is committed back to the Fabric Registry for the sensor network management module to “re-wire” the service connectivity by enabling the selected services instances and setting up routing appropriately.

A runtime model for writing policies applicable to the service composition process (and evaluated by the PDP in the sensor fabric node as in FIG. 5) was developed using the Policy Management Library (PML) framework which is a Java-based framework for analysis, negotiation, distribution and evaluation of policies using the standards-based common information model simplified policy language (CIMSPL) from Distributed Management Task Force (DMTF), Inc, Portland, Oreg. The runtime model represents a dynamic instance of the composite service graph and provides Java instance classes that describe the entities of service graphs such as nodes (i.e., service instances) and edges (i.e., connections among service instances), following the service model described above. In the runtime model, a number of standard graph-based functions can be implemented that compute certain characteristics of the composite service graph such as connectivity, path length, diameter, etc. Policies in simplified policy language SPL can make use of such methods implemented in the runtime classes that represent the service graph entities.

As nodes are composed, the runtime model is updated with the new service instances (nodes) and connections that are selected by the policy-enabled service composition method. This allows the evaluation of global policies that are applicable to the whole graph, and not just the current service node that is being composed. It also provides flexibility of executing policy evaluation in an incremental fashion both during the composition process and after the service graph is fully composed. This distinguishes the present techniques from other recent proposals for policy-aware service composition, such as that described in She, which assume availability of the fully composed composite service graph before evaluating any policies. Furthermore, it allows for early elimination of service instances that are not compliant with pre-specified policies. Upon completion of service composition, policies that require the full graph to be evaluated can now be checked. In the following section, the additional overhead introduced by the new policy checking is evaluated through experiment.

Evaluation:

the prototype system for policy-aware service composition in the Sensor Fabric described above was used to conduct preliminary experiments to evaluate the performance of the present techniques. The evaluation focused on gaining insights into the following two questions: (a) how much does policy checking contribute to a slow-down in completing the service composition process compared to the baseline (i.e., without policies)? (b) how much does the composition cost of services increase as one limits the available options for service selection via constraints during the composition process? Both questions are important in the context of sensor networks—on the one hand, the dynamics of the sensor environment call for frequent re-compositions, which could be delayed due to the extra policy checking that is introduced. On the other hand, as sensor network resources are limited, there is interest in keeping the communication and processing costs of the composite service as low as possible, a task that depends on the availability of multiple services instances.

Experimental Setup:

a utility application was developed that is able to generate composite service graphs (i.e., descriptions of service instances and how they can be inter-connected with one another) of arbitrary size in the Sensor Fabric. The service graphs are laid out in a grid form. For example, multiple service composition graphs like that shown in FIG. 1 are laid out in a grid. Thus, the grid is a collection of service composition graphs, i.e., many service composition graphs can be created based upon candidate services and policies. According to an exemplary embodiment, the grid consists of N service levels with M services per level. The M services of the first (top) level in the grid represent the sink services, which are used as the user-requests to be automatically composed and which produce no outputs. The M service instances of the bottom level N are considered source services, which produce only outputs but have no inputs themselves. All other services of the intermediate levels have a random number of inputs and outputs, each assigned a random data type. For all service levels, outputs of services of level i may provide data to the inputs of services of level (i−1) if their respective data types match. The composite service generator utility guarantees that only inputs and outputs of services of adjacent levels can be “connected” with one another, namely that they share data type. Additionally, the generator guarantees that there is always at least one service instance of level i whose output can provide data to an input a service of level (i−1). Thus, a composite service graph for all user-requests (sinks) of the first service level always exists, with a “depth” of N.

In this example, a 6×6 grid of service instances was generated with a maximum of 4 inputs and 3 outputs per service instance (randomly chosen), whose cost represents both processing and communication cost and is randomly chosen between 0 and 50. The types of the inputs and outputs of the services in the grid are randomly chosen from a set of 4 different types, so as to guarantee rich connectivity among the services of adjacent levels. The policies that were used for evaluation in this example are simple: each policy refers to an attribute of a single service instance in the grid, and can evaluate to true or false. Also, a single Sensor Fabric node stores all the service descriptions and their interconnections as generated by the composite service generator. This basic experimental scenario was followed deliberately: seek to establish the baseline performance of runtime overhead that policy evaluation introduces to the service composition process, as well as to the cost of the composite service graph.

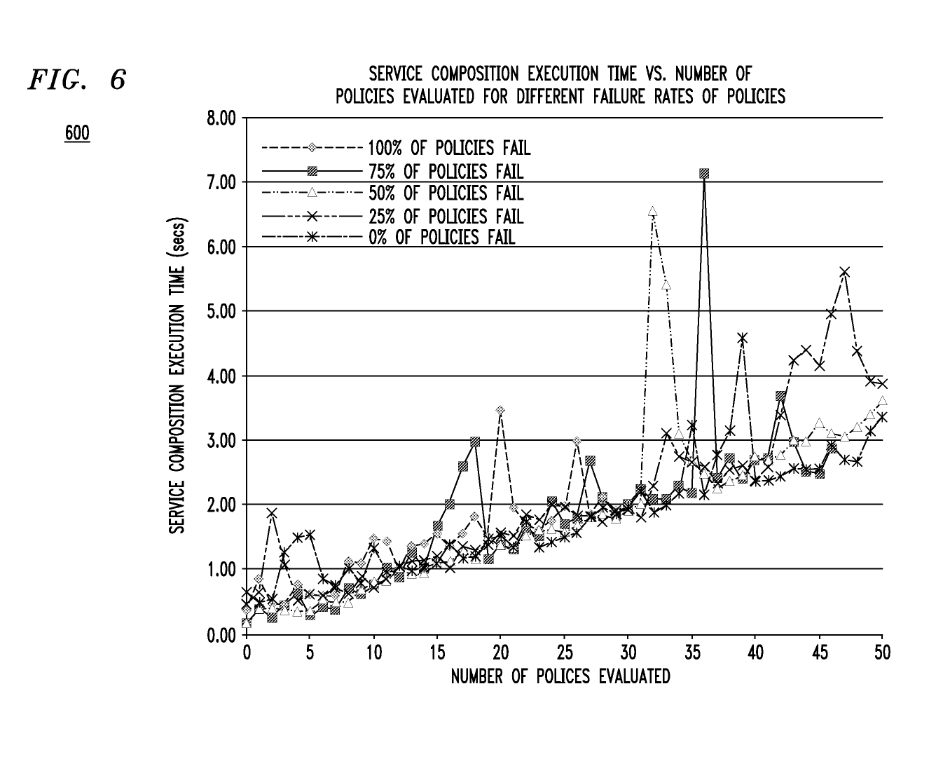

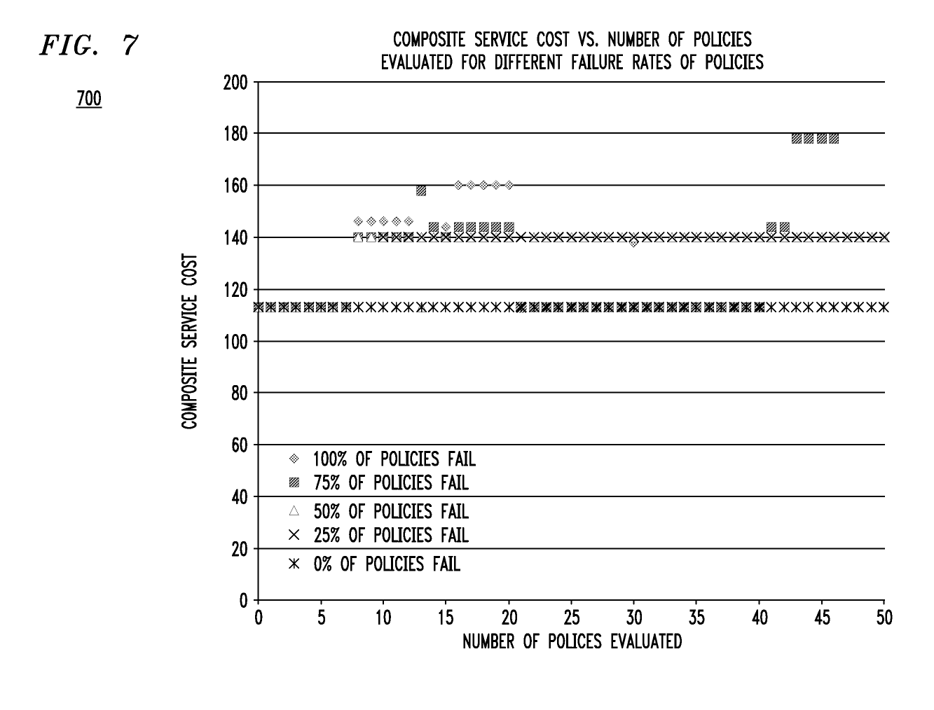

Results: the graph 600 in FIG. 6 shows the results of execution time (y-axis) required for service composition with policy evaluations, for different number of policies (x-axis) deployed in the service grid. Results are shown for different failure rates of the policies that have been deployed. Failed policies are those that are violated and thus do not allow the selection of the node that they refer to. For each data point, results are averaged over three runs. As can be seen from graph 600, there is an increase in the time that is needed to perform service composition as the number of policies that need to be evaluated is increased. More specifically, one can observe a linear trend, which is attributed to the fact that each policy that is evaluated refers to an attribute of a single service instance.

The graph 700 in FIG. 7 plots the total cost (y-axis) of the final composite service that has been generated by the service composition method, as a function of the number of policies (x-axis) that have to be checked. Results are again shown for various failure rates of policies, with each data point representing the average of three runs. As it is shown in FIG. 7, an increase in the number of policies that might fail leads to an increase in the cost of the composite service that the method synthesizes. This is due to the fact that, as policies are introduced that fail (i.e., are violated), the service nodes that are referenced by them are excluded from being selected for composition. Consequently, the composition methodology is forced to choose an alternative service instance that might not be as economical as one that could have been chosen if a policy that referred to it had not failed. This is also the reason for which, when there is a large number of policies that fail, composition of a given request might not even be feasible at all. This is also observed in FIG. 7 as certain data points (particularly for high failure rates) are completely missing—the service composition run completely failed in that case and did not manage to generate a valid composite service graph.

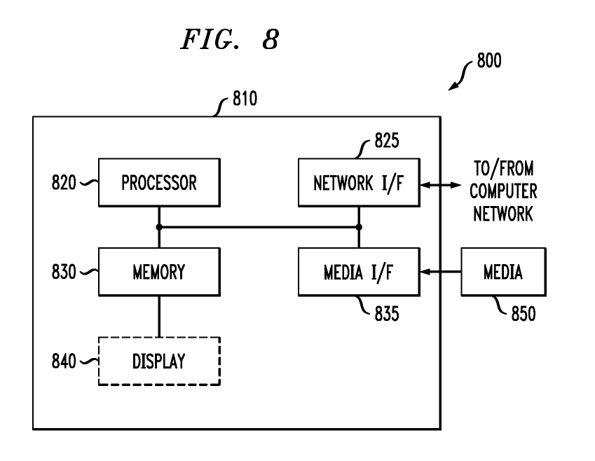

Turning now to FIG. 8, a block diagram is shown of an apparatus 800 for implementing one or more of the methodologies presented herein. By way of example only, apparatus 800 can be configured to implement one or more of the steps of methodology 400 of FIG. 4 for creating a policy-compliant service composition.

Apparatus 800 comprises a computer system 810 and removable media 850. Computer system 810 comprises a processor device 820, a network interface 825, a memory 830, a media interface 835 and an optional display 840. Network interface 825 allows computer system 810 to connect to a network, while media interface 835 allows computer system 810 to interact with media, such as a hard drive or removable media 850.

As is known in the art, the methods and apparatus discussed herein may be distributed as an article of manufacture that itself comprises a machine-readable medium containing one or more programs which when executed implement embodiments of the present invention. For instance, when apparatus 800 is configured to implement one or more of the steps of methodology 400 the machine-readable medium may contain a program configured to create one or more policy rules related to services in the service composition; create a service composition graph that represents the service composition, wherein vertices of the service composition graph represent the services and directional edges of the service composition graph represent potential flows of data between the vertices; determine during creation of the service composition graph whether one or more candidate services comply with the policy rules; and include only those of the candidate services that comply with the policy rules in the service composition graph, wherein the services included in the service composition graph comprise policy-compliant services, such that the service composition graph comprises only the policy-compliant services.

The machine-readable medium may be a recordable medium (e.g., floppy disks, hard drive, optical disks such as removable media 850, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor device 820 can be configured to implement the methods, steps, and functions disclosed herein. The memory 830 could be distributed or local and the processor device 820 could be distributed or singular. The memory 830 could be implemented as an electrical, magnetic or optical memory, or any combination of these or other types of storage devices. Moreover, the term “memory” should be construed broadly enough to encompass any information able to be read from, or written to, an address in the addressable space accessed by processor device 820. With this definition, information on a network, accessible through network interface 825, is still within memory 830 because the processor device 820 can retrieve the information from the network. It should be noted that each distributed processor that makes up processor device 820 generally contains its own addressable memory space. It should also be noted that some or all of computer system 810 can be incorporated into an application-specific or general-use integrated circuit.

Optional display 840 is any type of display suitable for interacting with a human user of apparatus 800. Generally, display 840 is a computer monitor or other similar display.

In conclusion, due to their distributed method of deployment, sensor network applications naturally fit a composition paradigm that interconnects multiple, light-weight aggregation and transformation data processing services that run on individual sensor nodes with one another, to develop a complete data collection and analysis application. As with any networked application, it is subject to resource management and security constraints that are expressed through policies. Provided herein is a policy-aware sensor service composition framework that can automate the process of combining simple sensor services into larger ones, while, at the same time, complying with pre-specified policies. Also provided herein is an implementation of the present framework in the Sensor Fabric, a middleware for developing sensor network applications and presenting preliminary performance evaluation results of the present techniques. The present system allows for the evaluation of attribute-based policies on service composition graphs, signifying a departure from the traditional focus on access control policies of prior proposals.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for creating a policy-compliant service composition, the method comprising the steps of:
creating one or more policy rules related to services in the service composition;
creating a service composition graph that represents the service composition, wherein vertices of the service composition graph represent the services and directional edges of the service composition graph represent potential flows of data between the vertices;
determining during creation of the service composition graph whether one or more candidate services comply with the policy rules; and
including only those of the candidate services that comply with the policy rules in the service composition graph, wherein the services included in the service composition graph comprise policy-compliant services, such that the service composition graph comprises only the policy-compliant services.

2. The method of claim 1, further comprising the step of:
adding a given one of the candidate services to the service composition graph if doing so would not violate any of the policy rules, otherwise eliminating the given candidate service from consideration.

3. The method of claim 1, wherein each of the policy rules contains constraints based on one or more of input data, output data and metadata associated with one or more of the services.

4. The method of claim 3, wherein the metadata comprises information about an affiliation of one or more of the services.

5. The method of claim 4, wherein the affiliation of a given one of the services comprises an entity with which the given service is affiliated.

6. The method of claim 3, wherein the metadata comprises information about a type of the service.

7. The method of claim 6, wherein the service composition comprises a sensor service composition, and wherein the type comprises one or more of a camera sensor service, a camera sensor recognition service, a triangular service, an event detector service, and an acoustic sensor service.

8. The method of claim 1, wherein at least one of the policy rules is global and contains constraints over more than one of the services in the service composition.

9. The method of claim 1, wherein at least one of the policy rules is local and contains constraints over a single one of the services in the service composition.

10. The method of claim 1, further comprising the step of:
determining whether a given one of the policy rules is applicable to a given one of the candidate services.

11. The method of claim 10, wherein a given one of the policy rules is applicable to a given one of the candidate services only if: 1) the given candidate service appears as a vertex in the service composition graph, 2) all of the services mentioned in the given policy rule appear as vertices in the service composition graph, and 3) there are paths in the service composition graph between the given candidate service and each of the services mentioned in the given policy rule.

12. The method of claim 1, further comprising the step of:
providing a set of the candidate services.

13. The method of claim 1, wherein the candidate services are the services in the service composition that an output of which can be consumed by one or more other of the services.

14. An apparatus for creating a policy-compliant service composition, the apparatus comprising:
a memory; and
at least one processor device, coupled to the memory, operative to:
create one or more policy rules related to services in the service composition;
create a service composition graph that represents the service composition, wherein vertices of the service composition graph represent the services and directional edges of the service composition graph represent potential flows of data between the vertices;
determine during creation of the service composition graph whether one or more candidate services comply with the policy rules; and
include only those of the candidate services that comply with the policy rules in the service composition graph, wherein the services included in the service composition graph comprise policy-compliant services, such that the service composition graph comprises only the policy-compliant services.

15. The apparatus of claim 14, wherein the at least one processor device is further operative to:
add a given one of the candidate services to the service composition graph if doing so would not violate any of the policy rules, otherwise eliminating the given candidate service from consideration.

16. The apparatus of claim 14, wherein at least one of the policy rules is global and contains constraints over more than one of the services in the service composition.

17. The apparatus of claim 14, wherein at least one of the policy rules is local and contains constraints over a single one of the services in the service composition.

18. The apparatus of claim 14, wherein the candidate services are the services in the service composition an output of which can be consumed by one or more other of the services.

19. An article of manufacture for creating a policy-compliant service composition, comprising a machine-readable recordable medium containing one or more programs which when executed implement the steps of:
creating one or more policy rules related to services in the service composition;
creating a service composition graph that represents the service composition, wherein vertices of the service composition graph represent the services and directional edges of the service composition graph represent potential flows of data between the vertices;
determining during creation of the service composition graph whether one or more candidate services comply with the policy rules; and
including only those of the candidate services that comply with the policy rules in the service composition graph, wherein the services included in the service composition graph comprise policy-compliant services, such that the service composition graph comprises only the policy-compliant services.
